(19) United States
(12) Patent Application Publication
(10) Pub. No.: US 2015/0001229 A1
(43) Pub. Date: Jan. 1, 2015

(54) METHOD OF PRODUCING A COMPOSITE PRESSURE VESSEL, AND COMPOSITE PRESSURE VESSEL

(71) Applicant: Kautex Textron GmbH & Co. KG, Bonn (DE)

(72) Inventors: Raimund Helmig, Bonn (DE); Ulrich Karsch, Niederkassel (DE); Harald Lehmann, Rheinbach (DE)

(73) Assignee: Kautex Textron GmbH & Co.KG, Bonn (DE)

(21) Appl. No.: 14/353,159

(22) PCT Filed: Sep. 28, 2012
(86) PCT No.: PCT/EP2012/004104

§ 371 Date: Apr. 21, 2014

(30) Foreign Application Priority Data
Oct. 21, 2011 (DE) 10 2011 116 553.7

(51) Int. Cl. F17C 1/02; B29C 49/04; B29C 49/20; F17C 1/16

(52) U.S. Cl. CPC F17C 1/02; F17C 1/16; B29C 49/04; B29C 49/20; F17C 2201/0109; F17C 2201/0123; F17C 2203/066; F17C 2209/2127; F17C 2209/219; F17C 2209/228; F17C 2209/234; B29C 2049/2026; B29C 2049/2043; B29K 2105/06
USPC 220/592; 264/515

(57) ABSTRACT

Method of producing a composite pressure vessel (1) having an inner vessel (4) made of thermoplastic material, having at least one end piece (6) provided in a neck region (2), and having a wrapping (5) which reinforces the inner vessel (4) and is made of a fibre material, wherein the method includes production of the inner vessel (4) by extrusion blow moulding and the end piece (6), while the inner vessel is being shaped, is formed on the inner vessel such that the end piece (6) is at least partially enclosed by the inner vessel (4).

The invention relates to a method of producing a composite pressure vessel having an inner vessel made of thermoplastic material, having at least one end piece provided in a neck region, and having a wrapping which reinforces the inner vessel and is made of a fibre material, wherein the method includes production of the inner vessel by extrusion blow moulding.

The invention also relates to a composite pressure vessel having an inner vessel made of thermoplastic material, having at least one neck region and at least one end piece, which is centred in the neck region of the vessel, and having a fibre wrapping which reinforces the inner vessel.

A composite pressure vessel for storing gaseous media under pressure having a liner made of plastics material is known, for example, from DE 196 31 546 C1. The composite pressure vessel according to DE 196 31 546 C1 comprises a liner made of plastics material and two neck pieces, which are arranged in the neck region, and a wrapping which reinforces the liner and is made of a fibre composite material, wherein at least one neck piece is designed for accommodating a screw-in valve. The liner or inner vessel may have been produced by a rotary process, a thermal process or by extrusion blow moulding. The neck pieces are anchored in a form-fitting manner to the liner. The neck piece is provided with an annular groove, in which the liner material engages in a form-fitting manner. In order to ensure that the neck region of the liner is sufficiently adapted to the neck piece to provide for adequate sealing, a clamping ring is pressed onto the end region of the liner.

Reliable sealing of the system is the most important factor of composite pressure vessels of the type described above. The design of the vessel allows a simplified production capability of the vessel only to a limited extent.

It is therefore an object of the invention to provide, in the first instance, a method which is intended for producing a composite pressure vessel of the type mentioned in the introduction and allows for simplified production of such a vessel while taking account of the sealing and, in particular, of the fastening of the neck piece on the inner vessel.

The object is achieved by a method of producing a composite pressure vessel having an inner vessel made of thermoplastic material, having at least one end piece provided in a neck region, and having a wrapping which reinforces the inner vessel and is made of a fibre material, wherein the method includes production of the inner vessel by extrusion blow moulding, and wherein the method is distinguished in that the end piece, while the inner vessel is being shaped in the blow mould, is formed on the inner vessel such that the end piece is at least partially enclosed by the inner vessel. This makes it possible, in a particularly straightforward manner, for the end piece to be introduced into the inner vessel and, at the same time, connected in a form-fitting manner to the inner vessel. The end piece is arranged preferably essentially in the interior of the inner vessel.

In a preferred variant of the method according to the invention, it is provided that the end piece is placed, on a mandrel-like or rod-like support element, between the open parts of a blow mould and, enclosed by a tubular molten parison or a plurality of web-like molten parisons, is pressed, with the parison, between the parts of the closing blow mould.

The mould may be provided, for this purpose, with central openings in each case. When the halves of the mould are closed around the mandrel-like or rod-like support element, the material of the parison/of the parisons is deformed against the support element, and around the support element, by the closing and abutting mould halves.

In the case of an expedient variant of the method, it is possible to provide, for example, that two end pieces, each defining a neck region of the vessel, are spaced apart from one another on the support element.

The support element may be designed, for example, as a rod, which is provided, at least in part, with an external thread.

End pieces may be arranged at each end of the support element, in the region of the external threads. The end pieces may each be rotatable in relation to the support element such that for example the end pieces are each provided with an internal thread which engages in the external thread of the support element.

It is particularly expedient if the support element is used as a blowing mandrel, via which the parison is widened in the blow mould. For this purpose, it is possible for the support element to be, for example, of hollow design and to have radial outlet openings for blowing air.

The end piece is expediently connected in a form-fitting manner to the inner vessel during blow moulding. For this purpose, it is possible, for example, for the end piece to be provided with depressions and/or notches, into which the molten material of the parison penetrates during blow moulding. These depressions may, for example, also be undercut.

It is particularly expedient if the end piece, following completion of the inner vessel, is braced and/or secured against the wall of the vessel from the outside by a securing element. The end piece may have, for example, an externally threaded neck which passes through the opening remaining in the inner vessel and projects out of this opening. Once blow moulding has taken place around the end piece or the end pieces, the support element can be removed from the inner vessel, and an appropriately designed securing element can then be screwed onto the neck of the end piece from the outside, wherein the vessel wall, in the neck region, is clamped in between the end piece and the securing element, possibly with the interposition of one or more further parts. For example, it is possible to provide an end cap which engages around the inner vessel from the outside and is secured by the securing element.

As an alternative, it may be provided that the support element, following completion of the vessel, remains in the latter, the support element therefore being designed, as it were, as a “lost” support element.

The support element can also be used to introduce, for example, reinforcing elements, preferably in the form of wall segments extending radially from the support element, into the vessel. While the inner vessel is being shaped, these reinforcing elements are then welded to the inner wall of the vessel or, depending on the outer contour of the mould, connected in a form-fitting manner to the wall of the inner vessel.

The object on which the invention is based is also achieved by a composite pressure vessel having an inner vessel made of thermoplastic material, having at least one neck region and at least one end piece, which is centred in the neck region of the inner vessel, and having a fibre wrapping which reinforces the inner vessel, wherein the composite pressure vessel is distinguished in that the end piece is arranged, at least in part, within the inner vessel and is fastened on the inner vessel in a rotationally secure manner in relation to the same.

The inner vessel may consist, for example, of an extrudate made of one or more layers of HDPE-based thermoplastic material. The fibre wrapping may consist, for example, of carbon, aramid, glass, Al₂O₃ fibres or mixtures thereof. The fibres are preferably embedded in a thermoplastic or duroplastic matrix. The fibres may be embedded in a matrix made of epoxy or phenolic resins or, for example, in a polypropylene/polyamide or polyethylene/polyamide matrix.

The operation of applying such a fibre reinforcement or fibre wrapping, which can be applied both tangentially and axially, is known per se from the prior art.

The end pieces may consist of metal and/or plastics material.

In the case of an expedient configuration of the composite pressure vessel, it is provided that the end piece has a threaded stub which passes through the neck of the inner vessel and on which an end cap is fastened, wherein the wall of the inner vessel, in the neck region, is clamped in between the end piece and the end cap. The threaded stub of the end piece may be formed on to form a single part. However, it is also possible, in principle, for the end piece to be designed in a number of parts. The end cap is expediently secured by means of a securing element.

The inner vessel is preferably provided with at least one support element which passes through it and retains or accommodates an end piece at each end.

The preferred variant of the composite pressure vessel is distinguished in that two neck regions of the vessel are each provided with an end piece arranged in a centred manner in each case in relation to the relevant neck region.

The composite pressure vessel may be designed as a rotationally symmetrical part.

The invention will be explained hereinbelow with reference to an exemplary embodiment illustrated in the drawings, in which:

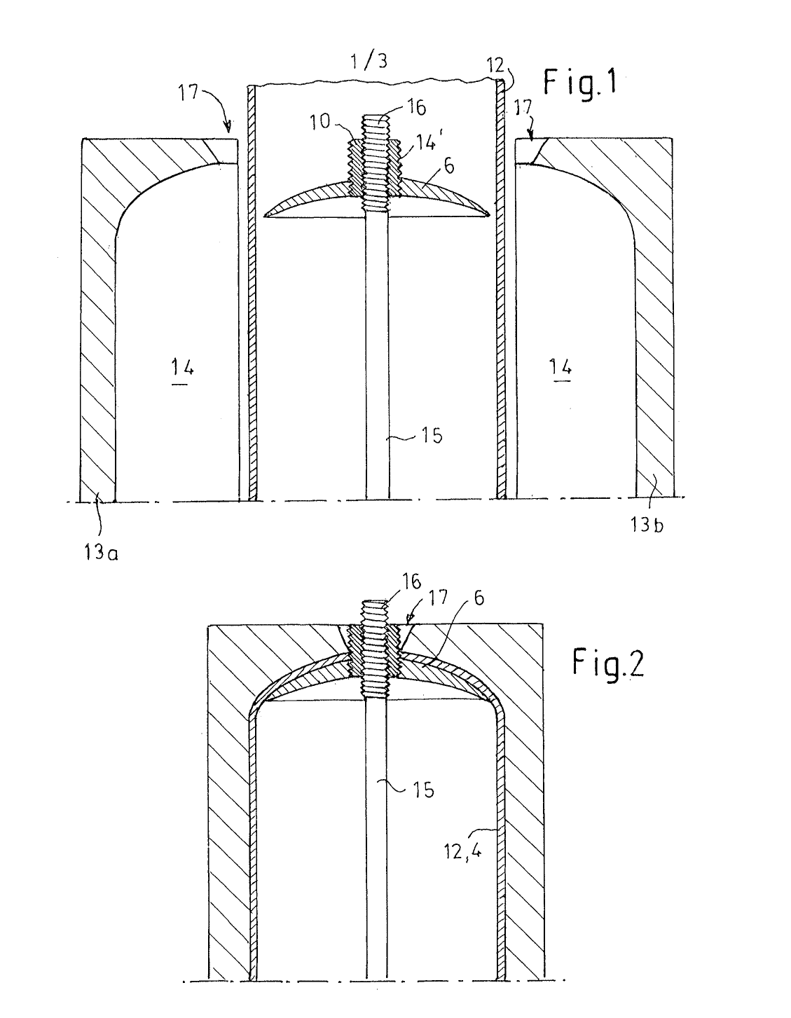

FIGS. 1 and 2 each show sections through the blow mould during the operation of shaping the inner vessel of the composite pressure vessel,

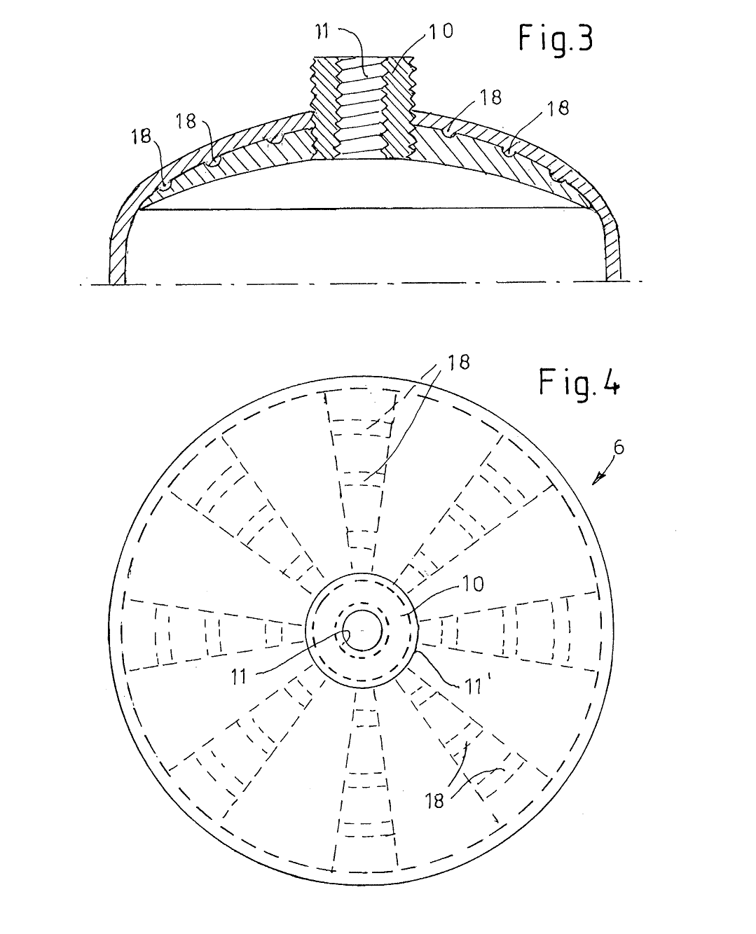

FIG. 3 shows a longitudinal section through the inner vessel with end piece inserted,

FIG. 4 shows a plan view of the end piece of the composite pressure vessel,

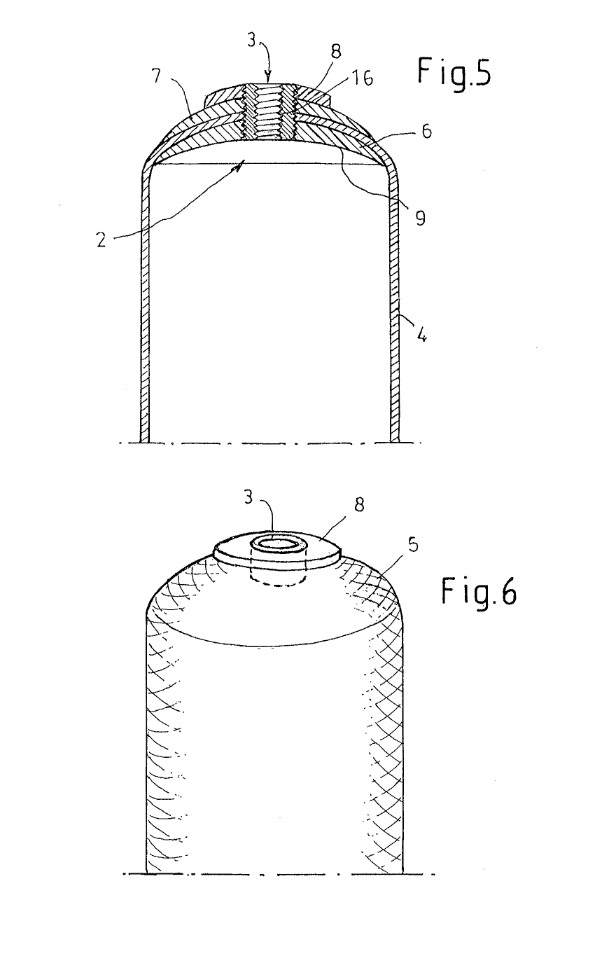

FIG. 5 shows a longitudinal section through the composite pressure vessel without the wrapping which reinforces the inner vessel, and

FIG. 6 shows a schematic external view of the composite pressure vessel according to the invention.

The composite pressure vessel 1 according to the invention is preferably designed as a pressure vessel for storing gaseous media under high pressure. “High pressure” within the context of the present application is to be understood as an operating pressure of 30 bar up to 700 bar.

The composite pressure vessel 1 is designed as an approximately cylindrical vessel of circular cross section and is rotationally symmetrical.

The vessel is provided, at both marked ends, with a neck region 2 and an opening 3 passing through the neck region. Each of the drawings illustrates just one end of the composite pressure vessel 1. The invention should be understood, in principle, such that the composite pressure vessel may have either one or two neck regions 2. The latter case is the norm.

A shut-off fitting (not illustrated) is inserted with sealing action into the opening 3 of the composite pressure vessel 1.

The composite pressure vessel 1 comprises an inner vessel 4 (see FIGS. 5 and 6), a reinforcing fibre wrapping 5, which is applied to the inner vessel 4, an end piece 6 at each end, an end cap 7, which interacts with the end piece 6, and a securing element 8. The arrangement of the end piece 6, end cap 7 and securing element 8 defines in each case the neck region 2 of the composite pressure vessel 1 according to the invention.

The end piece 6, which preferably consists of metal, comprises a base 9, which is arranged in the interior of the inner vessel 4, and a threaded stub 10 which is formed on to form a single part. The threaded stub 10 is provided both with an internal thread 11 and an external thread 11′. The internal thread 11 is predominantly for accommodating the fitting which can be inserted into the composite pressure vessel 1, and the external thread 11′ interacts with corresponding threads of the end cap 7 and of the securing element 8. The end piece 6 and the end cap 7 clamp the inner vessel 4 in between them, and the securing element 8 secures the end cap 7 and end piece 6 in relation to one another. Both the base 9 of the end piece 6 and the end cap 7 are of approximately disc-like design, wherein this arrangement is likewise retained by the externally applied fibre wrapping 5, which is supported on the end cap 7. As has already been mentioned above, the fibre wrapping 5 may be provided, for example, in the form of an aramid-fibre wrapping or carbon-fibre wrapping, which has been applied to the inner vessel 4 axially and radially, for example, in a crosswise or layered manner, wherein the fibres are embedded in a thermoplastic or duroplastic matrix.

The inner vessel 4 consists, for example, of an HDPE-based multi-layered extrudate with barrier layers for hydrogen (EVOH). Of course, it is also possible for the inner vessel 4 to be constructed with just one layer.

As a result of the production method according to the invention, which will be discussed in more detail hereinbelow, the inner vessel 4 is closely adapted to the shape of the end piece 6 and terminates with sealing action at the threaded stub 10 of the end piece 6.

The end piece is generally also referred to in the prior art as “neck piece” or “boss”. The inner vessel is also referred to in the art as a “liner”.

Reference will now be made to FIGS. 1 and 2, which clarify the production method according to the invention.

The inner vessel 4 is obtained by the extrusion blow moulding of a tubular parison 12 which is expelled from an extrusion head (not illustrated in the figures). The parison 12 is placed between the open halves 13a, 13b of a blow mould. The blow-mould halves 13a, 13b are provided with cavities 14 which each define the contour of the finished inner vessel 4 and, with the blow mould closed, form a complete mould cavity. The parison 12 can be extruded immediately above the blow mould or the blow-mould halves 13a, 13b, in which case the parison is cut to length in the direction of gravitational force between the open blow-mould halves 13a, 13b. As an alternative, the parison 12 can be brought to the blow mould by means of a gripper arm or robot arm.

In the case of the method described, a tubular parison 12 is extruded, but the invention is also to be understood such that it is also possible for a plurality of web-like parisons to be used instead of a tubular parison.

The high-pressure application of the composite pressure vessel 1 according to the invention, however, renders an essentially seamless construction of the inner vessel 4 desirable, in which case extrusion of a tubular parison 12 is preferred.

FIG. 1 shows the open blow-mould halves 13a, 13b, which can execute an opening and closing movement towards one another and away from one another.

A support element 15 with two end pieces 6 arranged thereon is introduced from beneath into the extruded parison 12 made of molten plastics material, still in the plastic state, it being possible for the parison to be widened on a preliminary basis and/or stabilized, for example, from beneath by means of supporting air. The end pieces 6 have their internal thread 11 interacting in each case with a threaded portion 16 of the support element 15.

If the inner vessel 4 is produced from two parisons extruded in web form, the support element 15 can be placed laterally between the moulds and the parisons.

The blow-mould halves 13a, 13b are each provided with lead-throughs 17 which have cutting edges each adapted to the contour of the support element 15.

The end pieces 6 are spaced apart from one another on the support element 15 such that the contour of the base 9 fits into the corresponding contour of the cavities 14 when the blow-mould halves 13a, 13b are closed against one another, as is illustrated in FIG. 2. The threaded stub 10 of the end pieces 6 here extends into the lead-through 17 of the blow mould such that the pinch-off edges of the blow mould pinch off the parison 12 against the threaded stub 10 of the end piece 6.

The method comprises, in order, the operations of the parison 12 being extruded and of the support element 15, equipped with end pieces 6, being introduced into the stabilized tubular parison 12 from beneath. The blow-mould halves 13a, 13b are then closed and the parison 12 is widened, within the complete mould cavity, to the contour of the inner vessel 4. In the process here, the parison 12, in the neck region 2 of the inner vessel 4 which is to be produced, is pinched off against the threaded stub 10 of the end piece 6.

In order to achieve the situation where the end piece 6 is engaged with the inner wall of the inner vessel 4 in as intimate, rotationally secure and form-fitting a manner as possible, the end piece 6, as can be seen from FIGS. 3 and 4, is provided with a profile on its side which faces the inner vessel 4. For example, segment-like, radially extending depressions 18 are provided on the upper side of the end piece 6, and the molten material of the parison 12 penetrates into the same, this giving rise to rotationally secure engagement of the end piece in relation to the inner vessel 4.

Following completion of blow moulding of the inner vessel 4, the support element 15 can be removed from the inner vessel 4. End caps 7 are then screwed on from the outside, wherein in each case the end caps 7 and the end piece 6 clamp the inner vessel 4 in between them. The arrangement is secured by the securing element 8. The fibre wrapping 5 is then applied, wherein the fibre wrapping is supported on the outside of the end cap 7.

### LIST OF DESIGNATIONS

1 Composite pressure vessel

2 Neck region
3 Opening
4 Inner vessel
5 Fibre wrapping
6 End piece
7 End cap
8 Securing element
9 Base
10 Threaded stub
11 Internal thread
11′ External thread
12 Parison
13a, 13b Blow-mould halves
14 Cavities
15 Support element
16 Threaded portion
17 Lead-through
18 Depression

1. Method of producing a composite pressure vessel having an inner vessel made of thermoplastic material, having at least one end piece provided in a neck region, and having a wrapping which reinforces the inner vessel and is made of a fibre material, wherein the method includes production of the inner vessel by extrusion blow moulding, characterized in that the end piece, while the inner vessel is being shaped, is formed on the inner vessel such that the end piece is at least partially enclosed by the inner vessel.

2. Method according to claim 1, characterized in that the end piece is placed, on a mandrel-like or a rod-like support element, between the open parts of a blow mould and, enclosed by a tubular molten parison or a plurality of web-like molten parisons, is pressed, with the parison, between the parts of the closing blow mould.

3. Method according to claim 1, characterized in that two end pieces, each defining a neck region of the vessel, are spaced apart from one another on the support element.

4. Method according to claim 1, characterized in that the support element provided is a rod, which is provided, at least in part, with an external thread.

5. Method according to claim 1, characterized in that the support element is used as a blowing mandrel, via which the parison is widened in the blow mould.

6. Method according to claim 1, characterized in that the end piece is connected in a form-fitting manner to the inner vessel during blow moulding.

7. Method according to claim 1, characterized in that the end piece, following completion of the inner vessel, is secured against the wall of the vessel from the outside by a securing element.

8. Method according to claim 2, characterized in that the support element, following completion of the vessel, remains in the latter.

9. Method according to claim 1, characterized in that the support element is used to introduce reinforcing elements, preferably in the form of wall segments, into the vessel.

10. Composite pressure vessel having an inner vessel made of thermoplastic material, having at least one neck region and at least one end piece, which is centred in the neck region of the vessel, and having a fibre wrapping which reinforces the inner vessel, characterized in that the end piece is arranged, at least in part, within the inner vessel and is fastened on the inner vessel in a rotationally secure manner in relation to the same.

11. Composite pressure vessel according to claim 10, characterized in that the end piece is designed in two parts and comprises an end cap arranged outside the inner vessel, wherein the wall of the inner vessel, in the neck region, is clamped in between the end piece and the end cap.

12. Composite pressure vessel according to claim 10, characterized in that the end piece has a threaded stub which passes through the neck region of the inner vessel and on which the end cap is fastened.

13. Composite pressure vessel according to claim 11, characterized in that the end cap is secured by means of a securing element.

14. Composite pressure vessel according to claim 10, characterized in that the inner vessel has a support element which passes through it and retains an end piece at each end.

15. (canceled)
